(19) United States
(12) Patent Application Publication
(10) Pub. No.: US 2012/0143751 A1
(43) Pub. Date: Jun. 7, 2012

(54) GIFT CARD SYSTEM INCLUDING VIRTUAL GIFT CARD AND CARD AGGREGATOR

(76) Inventor: Steven Kravec, Newtown, CT (US)

(21) Appl. No.: 12/959,629

(22) Filed: Dec. 3, 2010

(51) Int. Cl. G06Q 40/00; G06Q 30/00

(52) U.S. Cl. 705/41; 235/375; 705/39

(57) ABSTRACT

A method for execution on a computing device includes the steps of receiving information from a user to be included in a user profile, and establishing a user account associated with the user profile. The account has an identifier and an account balance; the balance is in accordance with funds expended by the user or received by transfer from another user. A user device is caused to display an image representing the account identifier; an external system (e.g. at a retailer) is permitted access to the account by recording the image. A user-initiated transaction (e.g. a retail purchase) is processed in accordance with information transmitted by the external system (e.g. over a network); this processing includes updating the account balance in accordance with the transaction. The displayed image may be a bar code scannable by the external system.

### FIELD OF THE DISCLOSURE

This disclosure relates generally to cashless commerce, and more particularly to prepaid cards usable in a variety of transactions, and a system supporting the use of physical and virtual gift cards.

### BACKGROUND OF THE DISCLOSURE

Gift cards are issued by a wide variety of retailers to build traffic to their stores and promote customer loyalty. Since a gift card carries a prepaid value, a customer presenting a gift card at a store generally will have the card accepted as cash—provided that the card was issued by that store. A customer looking for a particular item, and desiring to pay for that item with a gift card, must carry multiple cards as s/he travels from store to store. A card depleted of value is often simply thrown away. Conventional gift cards thus can be inconvenient for the customer and present an environmental problem.

Conventional gift cards are limited in their use (intentionally so by the retail issuer). For example, a card holder typically cannot transfer value from one card to another, or transfer value to another person's card. Funds transferred to a conventional card are committed to purchases at a particular retailer. Furthermore, a customer wishing to use funds on a card generally must present the physical card at the point of purchase.

Accordingly, it is desirable to implement a gift card system where a prepaid card may be used at many different stores, and may have value added to it indefinitely.

### SUMMARY OF THE DISCLOSURE

The present disclosure provides a card system in which a prepaid card may be used at a wide variety of retailers, and aggregates numerous other functions including that of a gift card.

In accordance with an aspect of the disclosure, a method for execution on a computing device includes the steps of receiving information from a user to be included in a user profile, and establishing an account of the user associated with the user profile. The account has an account identifier and an account balance; the account balance is in accordance with funds expended by the user or received by transfer from another user. A user device is caused to display an image representing the account identifier; an external system is permitted access to the account by recording the image and thereby acquiring the account identifier. A user-initiated transaction is then processed in accordance with information transmitted by the external system (e.g. over a network); this processing includes updating the account balance in accordance with the user-initiated transaction. In an embodiment, the displayed image is a bar code scannable by the external system, and the user-initiated transaction is a purchase of goods or services from an operator of the external system.

In accordance with another aspect of the disclosure, a computer-readable medium has stored thereon instructions for performing a method executing a computing device, where the method includes the steps described above.

In accordance with another aspect of the disclosure, a system includes a server and a storage device; the system is configured to perform a method with steps as described above.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 schematically illustrates a ‘white card’ system with a plurality of users.

FIGS. 2A and 2B are flowcharts illustrating a gifting process from the viewpoints of the giftor and giftee respectively, in accordance with an embodiment of the disclosure.

FIG. 3A illustrates an encoded ‘white card’ displayed on a personal computing device, in accordance with an embodiment of the disclosure.

FIG. 3B illustrates a display of recent activity by the user of a ‘white card’ system in accordance with an embodiment of the disclosure.

FIG. 4 is a block diagram illustrating a retail purchase using a ‘white card’ according to an embodiment of the disclosure, and further illustrating relationships among the system provider, the customer and the retailer.

FIG. 5 is a flowcharts illustrating a retail purchase according to an embodiment of the disclosure, where the customer presents a ‘white card’ as shown in FIG. 3A.

FIGS. 6A and 6B schematically illustrate using a ‘white card’ system according to an embodiment of the disclosure to make a transfer of funds between individual card holders.

FIG. 6C illustrates a display on a personal computing device facilitating a transfer as illustrated in FIGS. 6A and 6B.

FIG. 7 schematically illustrates a system on which a ‘white card’ system may be implemented, according to an embodiment of the disclosure.

### DETAILED DESCRIPTION

In accordance with the disclosure, a gift card system permits use of a card at any retailer; may have value added to it by the user an indefinite number of times; may be implemented in a non-physical fashion; and may be used to transfer funds to another person remotely and privately (that is, without involvement by a conventional financial institution).

### Overview of System

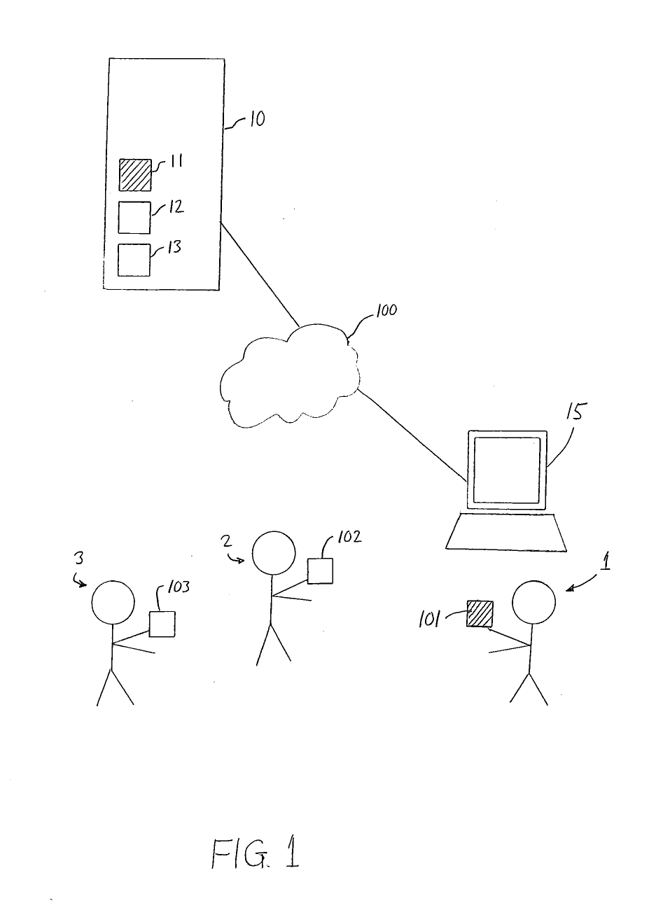

A schematic overview of a system embodying the disclosure is shown in FIG. 1. The system includes a server 10 communicating via the Internet 100 with a computing device 15. Device 15 is generally a personal computing device which may have any of a variety of configurations. User 1 registers as a client of the system by inputting personal information using device 15, and thereby establishes a user account 11. Information regarding user account 11 is shown schematically as resident on server 10, but may alternatively be located on a storage device coupled to server 10 or another server or storage unit accessible via the Internet.

User 1 holds a card 101 associated with account 11, and reflects the monetary value stored in the account. Unlike a conventional retailer gift card, the card may be used in any retail establishment; the card accordingly is referred to herein as a ‘white card.’. User 1 may add value to the card as often as desired, by a variety of methods discussed in detail below. A user may thus retain a card indefinitely; a card depleted of value need not be discarded. Furthermore, value may be transferred between users (e.g. users 2 and 3, with accounts 12, 13 and cards 102, 103) by sending appropriate instructions to server 10. Server 10 is maintained by the system provider (the white card issuer).

In an embodiment, user 1 purchases a white card with a predetermined value at a typical establishment (retail store, kiosk, etc.) and then registers him/herself as an account holder using his/her own computing device 15, thereby establishing a user profile and opening account 11. In this embodiment, a human-readable card number is printed or embossed on the card, identifying the card and indicating the initial purchase value. The system then associates the user profile with the card identifier, and updates the account to reflect the initial value of the card. The user may make a wide variety of transactions (with or without the physical card, as detailed below), which are reported to the system and result in updates to the account.

### Making a Gift

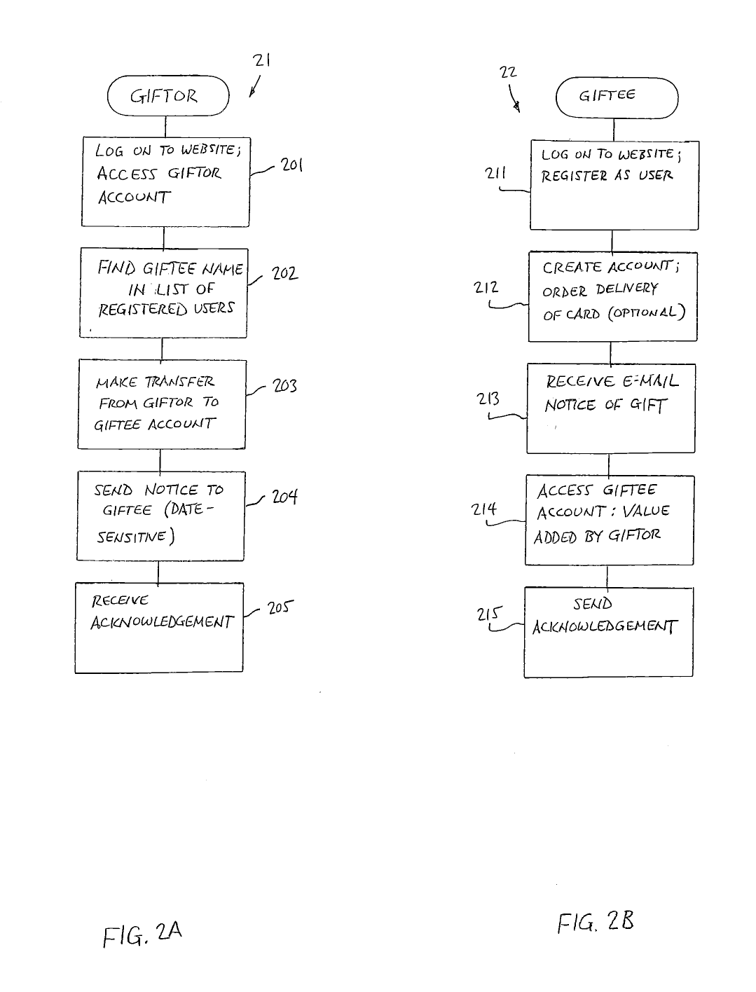

A procedure for making a gift using a white card, in accordance with an embodiment of the disclosure, is shown in FIGS. 2A and 2B (from the giftor's and giftee's point of view, respectively). In this example, it is assumed that at beginning of the process the giftor has an account (such as account 11 in FIG. 1), but the giftee does not.

The giftor procedure 21 begins with the giftor logging on to the system via a website maintained by the system provider, and accessing his/her account (step 201). Meanwhile the giftee procedure 22 begins with the giftee logging on to the system and registering as a user (step 211); it should be noted that one may register as a user, and establish an account, even though one does not hold a card and does not have any funds in the account. The giftee may order a physical card at this point (step 212). The giftor then finds the giftee in the list of registered users (step 202); the giftee may be listed either under his/her own name or by nickname.

The giftor then makes a transfer between the accounts (step 203) and arranges for an email to be sent to the giftee (step 204). This email need not be sent immediately, but instead may be sent on a future date (e.g. the giftee's birthday) selected by the giftee. When the giftee receives this email (step 213), s/he is prompted to access his/her own account and see that value has been added by the giftor (step 214). The system then sends an acknowledgement of the gift on behalf of the giftee (step 215) which is received by the giftor (step 205) and serves as confirmation that the gift was completed.

### Making a Purchase: Virtual Card

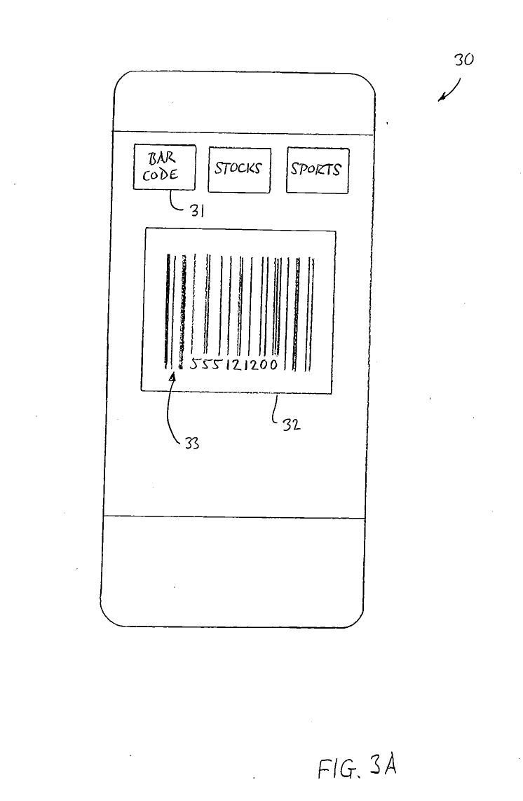

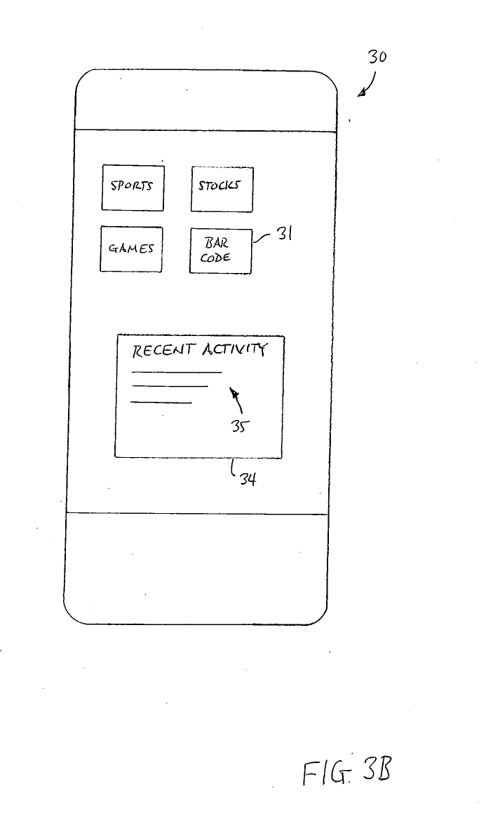

After a cardholder's account (e.g. account 11 belonging to user 1, holding physical card 101) has had value added thereto, the cardholder may use the card to make a purchase at any retailer. In another embodiment, user 1 need not carry a physical card, but instead arranges to carry a virtual card on his/her personal computing device 30 (FIG. 3A). This may be done by downloading an application from the system provider to a cell phone, messaging device, or the like (“phone app”) so that the device displays an image 32 with a scannable code representing the white card account. In a specific embodiment, the scannable code in image 32 is a bar code, such as bar code 33. This display is activated by the user pressing on a button 31 (labeled “Bar Code” in this embodiment) which itself is typically a displayed icon rather than a physical button on the device 30.

To complete a purchase, the store uses its bar code scanner to scan the bar code 33 in image 32 on the user's device 30. (More generally, the store retrieves necessary information regarding the user's white card account from the image.) The user's white card account is then debited by the amount of the purchase. When the virtual card is not being used to make a purchase, the app may instead present a display 34 showing the recent transactions 35 involving the account (FIG. 3B).

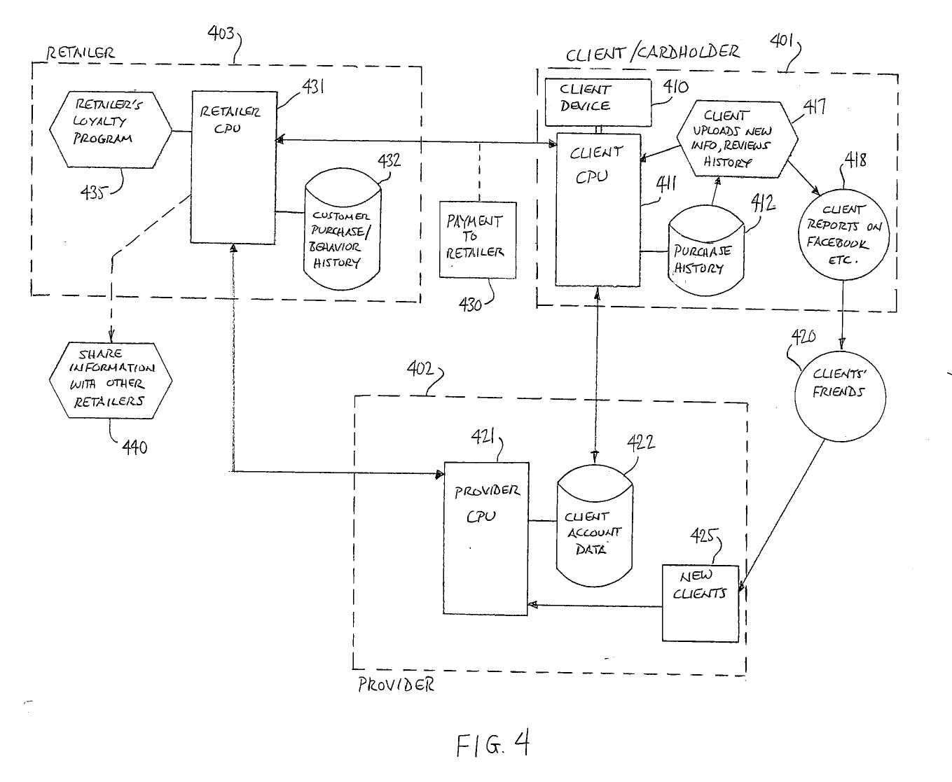

Relationships between the computing environments of the system provider, the user and the retailer when a purchase is made, according to embodiments of the disclosure, are shown schematically in FIG. 4. The cardholder 401 uses device 410 to present a virtual white card to the retailer; device 410 has a processor 411 associated therewith, either as part of the device or accessible over a network. Processor 411 is connected to a storage device 412 for keeping local records of purchases (or other transactions) made with the card. A new local record 417 is created at each purchase; the user may thus review activity involving the card without needing to log on to his/her system account. The user may upload news, comments, etc. regarding his/her activities to other accounts 418, e.g. Facebook. The user's friends 420, learning of the user's experience with the card (or virtual card), are motivated to become new users 425 of the system.

System provider 402 maintains a processor 421 and an associated storage device 422 to receive, process and store information relating to the transaction from both the cardholder 401 and the retailer 403. When the user's card (physical or virtual) is presented to make payment 430 to the retailer, information on the card (e.g. bar code 33) is transferred from the user to the computing device 431 of the retailer 403. When the retailer's computing device 431 sends a message informing the system provider that a purchase has been made, the provider's computing device 421 records details of the transaction in storage unit 422, updates the balance in the user's account, and sends a message to the user confirming the new balance.

Retailer 403 maintains a record of the user's purchases in a storage unit 432, and may also update the user's profile in a loyalty program 435 of the retailer. Information 440 regarding the purchase may also be sent by the system provider or retailer to other retailers, so that the user's preferences and loyalties across a range of stores may be followed for marketing purposes.

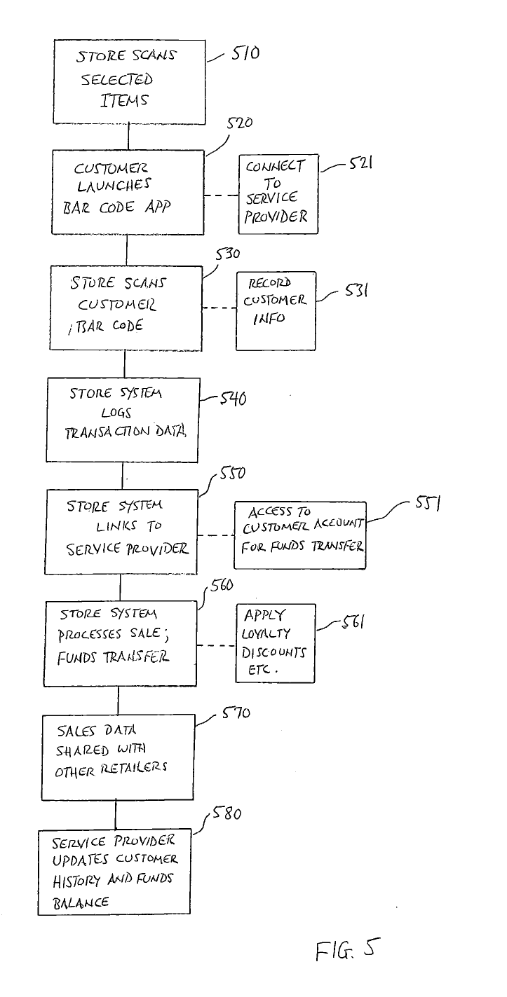

A procedure for using a virtual white card in a retail purchase, according to an embodiment of the disclosure, is shown in the flowchart of FIG. 5. The store scans the items selected by the cardholder (step 510), and the user then launches the app on his/her personal device (step 520) to display the bar code representing the white card account. Launching the app also causes the cardholder's device to connect to the system provider (step 521), so that information relating to the purchase is supplied, processed and recorded in real time.

The store scans the bar code displayed on the cardholder's device (step 530); the retailer's computing device accordingly records information relating to the customer encoded on the virtual card (step 531). Although the retailer does not have access to the cardholder's account, some elements of the cardholder's profile may be made available to the retailer from the system provider (e.g. for use in the retailer's loyalty program). The retailer's system then contacts the system provider (step 550) which in turn accesses the cardholder's account (step 551). The system provider effects a transfer of funds from the user's account to the retailer (step 560); the retailer may apply various discounts, depending for example on the user's participation in a loyalty program at that retailer (step 561). Data collected by the retailer during the transaction is optionally transmitted to the system provider to be shared with other retailers (step 570). The service provider updates the user's account balance and the user's purchasing history (step 580).

### Adding Value to a Card: Personal Transfers

As explained above, a card account may be established by a user's initial purchase of a card (followed by the user registering with the system provider), or as a result of a gift from a cardholder to another individual. In an additional embodiment, value may be added to a card after its initial purchase (or, more generally, added to a user's account after the account is established, whether or not the user holds a physical card) by transfer from another user. A card or a cardholder's account thus may be used to settle debts between users, or to permit expenses to be shared among users in real time.

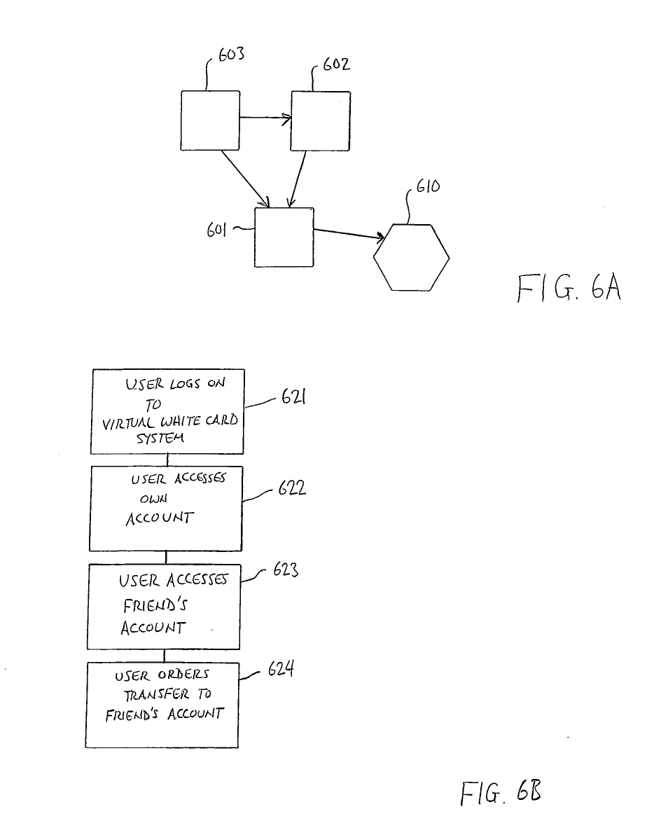

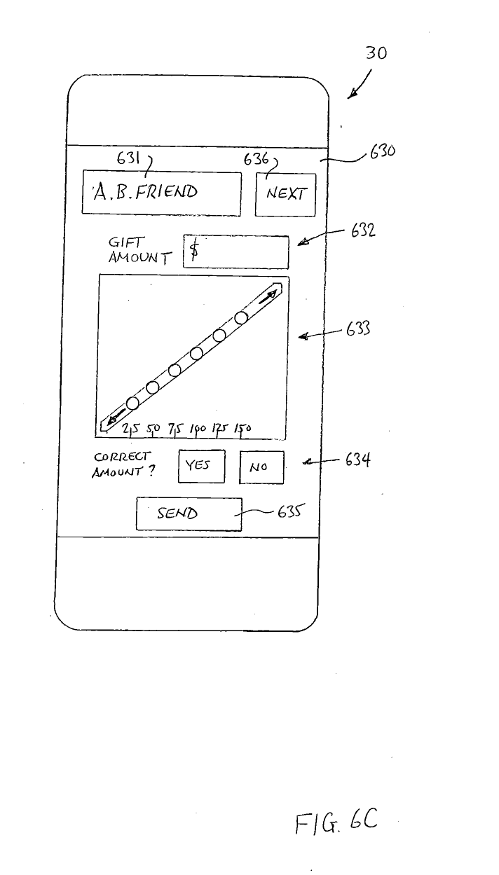

For example (see FIG. 6A), a cardholder 601 hosts a party at a restaurant 610, and his friends 602, 603 decide to share the expense. Cardholder 601 pays the bill to the restaurant using his card as described above; cardholders 602 and 603 reimburse 601 by making transfers from their respective accounts to 601's account (alternatively, 602 may reimburse 601 on behalf of both himself and 603, and 603 reimburses 602 afterward). In an embodiment, this is done by the procedure shown schematically in FIG. 6B. A user (in this example, cardholder 602) logs on to the system (step 621) and accesses his own account (step 622). Cardholder 602 then accesses the account of his friend 601, for the purpose of making a transfer to that account (step 623). It is understood that cardholder 602 need not have access to any account information of cardholder 601, or the user profile of cardholder 601; in particular, it is not necessary for cardholder 602 to know the balance of 601's account. Cardholder 602 then directs the system to make a funds transfer from his account to 601's account (step 624). An individual who is not an owner of an account may thus make a transfer of funds to that account. Funds transfers via this procedure are in one direction only; cardholder 602 is not permitted to transfer funds from 601's account to himself. In a further embodiment, the system may, with authorization from cardholder 601 and appropriate security and credentialing, permit another user (e.g. friends 602 and 603) to withdraw funds from 601's account.

Transfers from one account to another may be performed using a phone app with a display as shown in FIG. 6C. The user's device 30 presents a display 630 with a field 631 for entering the name of the user to whom a transfer is to be made; a field 632 showing the amount of the transfer or gift; and a field 633 graphically illustrating a range of transfer amounts. In this embodiment, the user making a transfer runs his/her finger along the diagonal slider in field 633, which is calibrated in dollar amounts; the amount displayed in field 632 increases and decreases as the slider is moved upward (to the right) and downward (to the left), respectively. When the desired transfer amount is displayed, the user presses a button 634 “YES” on the display. If the user instead types in an amount using the device's keyboard and then wishes to change that amount, the user presses “NO” and then may enter a different amount. The user may press a button 635 to effect the transfer, and then go to another application by pressing the NEXT button 636. As noted above, the buttons are typically icons in the display rather than physical buttons on the device.

### Adding/Redeeming Value on a Card: Cash Conversions

Since a card has prepaid value thereon and may be used at any retailer, it follows that a retailer's system may be used to convert value on the card and extract cash. In an embodiment, the user may present a card (either a physical card or a scannable displayed image representing the card) at a retailer, which then uses its system to deduct a requested amount from the card account and give the cardholder cash. The retailer may charge the user a fee for this transaction. Conversely, the user may give the retailer cash and request that equivalent value be added to the card account. In an embodiment, an individual may purchase a “zero value white card”—that is, a card that initially has no value associated therewith—by giving the retailer any desired sum in cash, immediately registering as a cardholder and creating a user profile, and having that card encoded with the purchase value. More generally, these transactions may be performed using any device configured to access the system, update a cardholder's account information, and accept or dispense cash (e.g. a kiosk, ATM, etc.).

### System Components

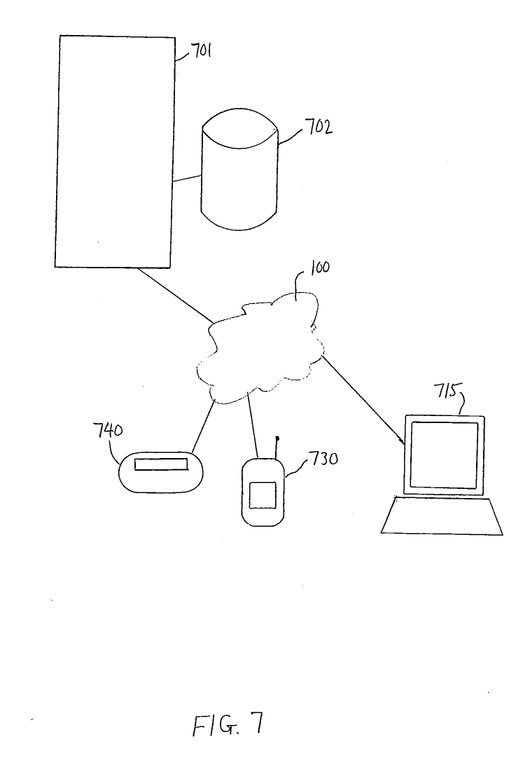

A system configured to execute and record transactions using a white card according to embodiments of the disclosure, and to maintain user profiles, is shown schematically in FIG. 7. Server 701, with storage device 702 connected thereto, communicates with user devices over a network such as the Internet 100. Users communicate with the server via any of a variety of devices such as a personal computer 715, a cell phone 730, a personal digital assistant or short-message system 740, or the like. One s/he has established a prepaid account and a user profile, the user may update the profile and/or initiate transactions over network 100.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. A method, for execution on a computing device, comprising the steps of:
receiving information from a user to be included in a user profile;
establishing an account of the user associated with the user profile and including an account identifier and an account balance, the account balance in accordance with funds expended by the user or received by transfer from another user;
causing a display, on a user device, of an image representing the account identifier;
permitting access to the account by an external system in accordance said system recording the image and thereby acquiring the account identifier; and
processing a user-initiated transaction in accordance with information transmitted by said external system, said processing including updating the account balance in accordance with said user-initiated transaction.

2. The method according to claim 1, wherein the image is a bar code scannable by said external system.

3. The method according to claim 2, wherein the user-initiated transaction is a purchase of goods or services from an operator of said external system.

4. The method according to claim 2, wherein the user-initiated transaction is one of
adding value to the account and
redeeming value from the account
in accordance with a cash transaction between the user and an operator of said external system.

5. The method according to claim 1, further comprising delivering a card to the user, the card having the account identifier and the account balance encoded thereon.

6. The method according to claim 5, wherein information to be encoded on the card is delivered to a user printing device over a network, and the card is produced by the user printing device.

7. The method according to claim 5, wherein said user-initiated transaction is processed by any of a plurality of said external systems, the card accordingly being characterized as a white card.

8. The method according to claim 7, wherein the user-initiated transaction comprises purchase of the white card for a purchase price, an initial value of the account balance being in accordance with the purchase price.

9. The method according to claim 2, wherein said system is permitted access to the account by communication over a network.

10. The method according to claim 1, further comprising:
receiving input from a first user including account information of a second user;
permitting access by the first user to the account of the second user in accordance with the received information;
causing a display, on the user device of the first user, of a range of possible amounts of funds to be transferred from the account of the first user to the account of the second user;
receiving input from the first user regarding a selected amount of funds in accordance with interaction by the first user with said display; and
processing transfer of the selected amount of funds from the account of the first user to the account of the second user, including updating the account balances of the first account and the second account in accordance with the selected amount of funds.

11. A system comprising:
a server configured to
receive information from a user to be included in a user profile,
establish an account of the user associated with the user profile and including an account identifier and an account balance, the account balance in accordance with funds expended by the user or received by transfer from another user,
cause a display, on a user device, of an image representing the account identifier,
permit access to the account by a system recording said image and thereby acquiring the account identifier, and
process a user-initiated transaction in accordance with information transmitted by said system, including updating the account balance in accordance with said user-initiated transaction; and
a storage device configured to store the user profile, the account identifier and the account balance.

12. The system according to claim 11, wherein the image is a bar code scannable by said external system.

13. The system according to claim 12, wherein the user-initiated transaction is a purchase of goods or services from an operator of said external system.

14. The system according to claim 12, wherein the user-initiated transaction is one of
adding value to the account and
redeeming value from the account
in accordance with a cash transaction between the user and an operator of said external system.

15. The system according to claim 11, wherein the server is further configured to
receive input from a first user including account information of a second user;
permit access by the first user to the account of the second user in accordance with the received information;
cause a display, on the user device of the first user, of a range of possible amounts of funds to be transferred from the account of the first user to the account of the second user;
receive input from the first user regarding a selected amount of funds in accordance with interaction by the first user with said display; and
process transfer of the selected amount of funds from the account of the first user to the account of the second user, including updating the account balances of the first account and the second account in accordance with the selected amount of funds.

16. A computer-readable storage medium having stored thereon instructions for executing a method on a computing device, the method comprising the steps of:
receiving information from a user to be included in a user profile;
establishing an account of the user associated with the user profile and including an account identifier and an account balance, the account balance in accordance with funds expended by the user or received by transfer from another user;
causing a display, on a user device, of an image representing the account identifier;
permitting access to the account by an external system in accordance said system recording the image and thereby acquiring the account identifier; and
processing a user-initiated transaction in accordance with information transmitted by said external system, said processing including updating the account balance in accordance with said user-initiated transaction.

17. The computer-readable storage medium according to claim 16, wherein the image is a bar code scannable by said external system.

18. The computer-readable storage medium according to claim 17, wherein the user-initiated transaction is a purchase of goods or services from an operator of said external system.

19. The computer-readable storage medium according to claim 17, wherein the user-initiated transaction is one of
adding value to the account and
redeeming value from the account
in accordance with a cash transaction between the user and an operator of said external system.

20. The computer-readable storage medium according to claim 16, further comprising:
receiving input from a first user including account information of a second user;
permitting access by the first user to the account of the second user in accordance with the received information;
causing a display, on the user device of the first user, of a range of possible amounts of funds to be transferred from the account of the first user to the account of the second user;
receiving input from the first user regarding a selected amount of funds in accordance with interaction by the first user with said display; and
processing transfer of the selected amount of funds from the account of the first user to the account of the second user, including updating the account balances of the first account and the second account in accordance with the selected amount of funds.
